(19) United States
(12) Patent Application Publication
(10) Pub. No.: US 2011/0174233 A1
(43) Pub. Date: Jul. 21, 2011

(54) Collapsible squirrel-proof bird feeder

(76) Inventor: Raymon W. Lush, Bloomfield, NE (US)

(21) Appl. No.: 12/657,347

(22) Filed: Jan. 19, 2010

(51) Int. Cl. A01K 39/01

(52) U.S. Cl. 119/498; 119/57.9

(57) ABSTRACT

A collapsible squirrel-proof bird feeder is disclosed comprising a collapsible bird feeder capable of being moved between an extended position and a collapsed position. A metal collapsible outer squirrel guard cage surrounds the collapsible bird feeder and is spaced therefrom and which is selectively movable between an extended position and its collapsed position. The collapsible outer squirrel guard cage has openings formed therein which are sized to permit birds to pass therethrough to feed from the collapsible bird feeder but small enough to prevent squirrels from passing therethrough to gain access to the collapsible bird feeder. The squirrel-proof bird feeder may be collapsed for shipping and storage purposes.

### BACKGROUND OF THE INVENTION

1. Field of the Invention

This invention relates to a collapsible squirrel-proof bird feeder and more particularly to a collapsible squirrel-proof bird feeder which includes a collapsible outer cage having a collapsible bird feeder therein.

2. Description of the Related Art

Many attempts have been made to provide squirrel-proof bird feeders. One method in attempting to prevent squirrels from gaining access to bird feeders is to provide an outer cage or haven which surrounds the bird feeder and which has openings formed therein which are sized to permit birds to enter the outer cage to gain access to the bird feeder but with those openings being small enough to prevent squirrels from entering the interior of the cage. To the best of Applicant's knowledge, all of the outer cages previously provided in the prior art to prevent squirrels from gaining access to a bird feeder within the outer cage are rigid. The fact that the outer cage is rigid detracts from the shipping and storage ability of the cage and bird feeder. In other words, the rigid outer cage cannot be reduced in size for shipping, storage or the like.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A collapsible squirrel-proof bird feeder is disclosed which comprises a collapsible bird feeder capable of being moved between an extended feeding position and a collapsed position. A metal collapsible outer squirrel guard cage surrounds a collapsible bird feeder and is spaced outwardly therefrom and which is selectively movable between an extended position and a collapsed position. The collapsible cage includes openings formed therein which are sized to permit birds to pass therethrough to feed from the collapsible bird feeder but small enough to prevent squirrels from passing therethrough to gain access to the collapsible bird feeder.

In one embodiment of the invention, a plurality of vertically stacked collapsible bird feeders are positioned within the metal collapsible outer cage. In the preferred embodiment, the collapsible bird feeder includes a collapsible metal mesh wall having feed openings defined therein when the bird feeder is in its extended position. In the preferred embodiment, the bird feeder includes structure which selectively maintains the outer cage in its extended position.

It is therefore a principal object of the invention to provide a squirrel-proof bird feeder.

A further object of the invention is to provide a collapsible squirrel-proof bird feeder.

A further object of the invention is to provide a collapsible squirrel-proof bird feeder which includes a collapsible bird feeder surrounded by a collapsible outer squirrel guard cage with the cage having openings sized therein which permits birds to enter the interior of the cage to feed from the bird feeder but which are sized small enough to prevent squirrels from entering the interior of the cage.

A further object of the invention is to provide a collapsible squirrel-proof bird feeder including a collapsible bird feeder having a collapsible squirrel guard cage extending therearound with both the bird feeder and squirrel guard cage being collapsible for shipment and storage purposes.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view illustrating the collapsible squirrel-proof bird feeder of this invention in its collapsed position;

FIG. 2 is a side view of the feeder of FIG. 1 in its collapsed position;

FIG. 3 is a side view of the bird feeder of this invention in its partially extended position;

FIG. 4 is an exploded perspective view of the bird feeder of this invention;

FIG. 5 is a side view of the bird feeder of this invention in its fully extended position;

FIG. 6 is a perspective view of the bird feeder of this invention in its fully extended position; and

FIG. 7 is a partial perspective view illustrating the construction of one of the cage units.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The collapsible squirrel-proof bird feeder of this invention is referred to by the reference numeral 10 and generally includes an outer metal collapsible squirrel guard cage 12 and an inner collapsible bird feeder assembly 14. Cage 12 will be described as having an upper end 16 and a lower end 18. Cage 12 is shown in the drawings as being comprised of identical cage units 20 and 22 although cage 12 could be comprised of a single cage unit or more than two cage units. Cage unit 20 includes an upper cage portion 20A and a lower cage portion 20B. Cage unit 22 includes an upper cage portion 22A and a lower cage portion 22B.

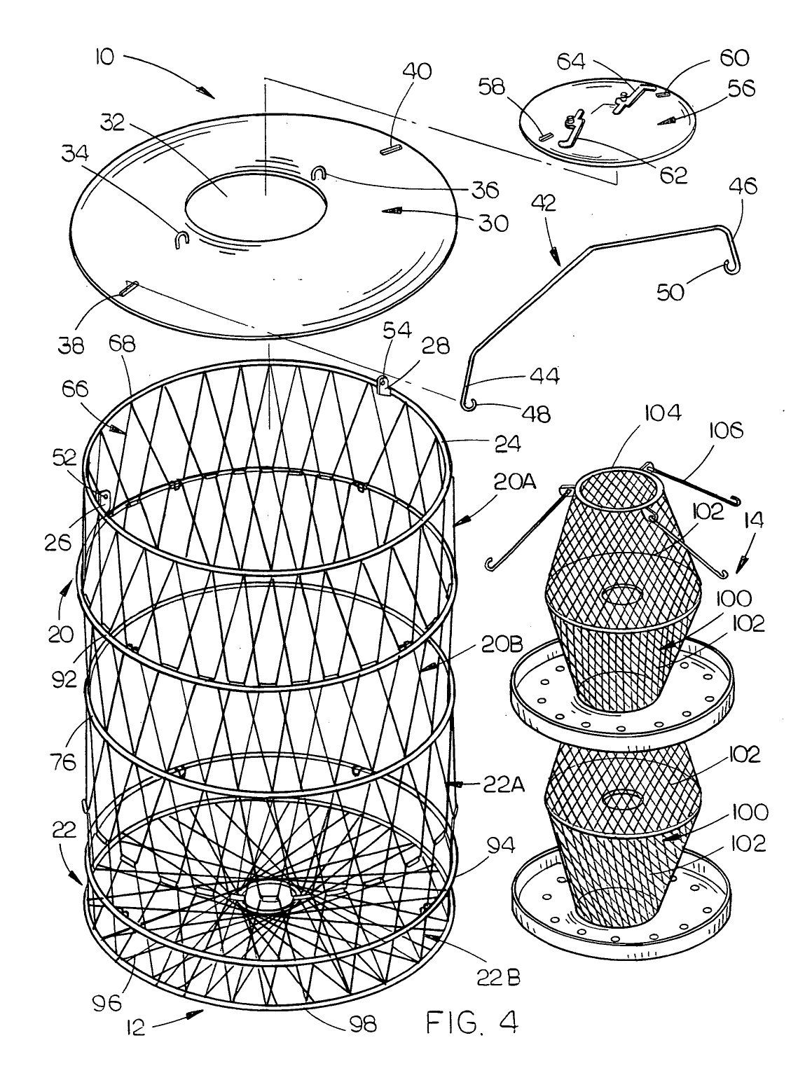

Cage unit 20 includes an upper support ring 24 having brackets 26 and 28 secured thereto and which extend upwardly therefrom. The numeral 30 refers to a metal disc-shaped plate having a central feed fill opening 32 formed therein. Plate 30 has a pair of spaced-apart brackets 34 and 36 secured thereto which extend upwardly from plate 30 at opposite sides of opening 32. Plate 30 also has a pair of spaced-apart slots 38 and 40 formed therein as seen in FIG. 4. The numeral 42 refers to a hanger bracket having leg portions 44 and 48 which have hooks 48 and 50 thereon respectively.

Plate 30 is positioned on support ring 24 so that brackets 26 and 28 extend upwardly through slots 38 and 40 of plate 30 respectively. Hooks 48 and 50 are pivotally secured to the openings 52 and 54 in brackets 26 and 28 respectively to provide a hanger for the assembly and to prevent upward movement of plate 30 with respect to support ring 24 to prevent squirrels from entering the upper end of the cage 20.

The numeral 56 refers to a disc-shaped lid having opposing slots 58 and 60 formed therein. Lid 56 also has a pair of pivotal spring-loaded locking hooks 62 and 64 mounted thereon. Lid 56 is selectively positioned over opening 32 of plate 30 so that brackets 34 and 36 of plate 30 extend upwardly through slots 58 and 60 respectively. Locking hooks 62 and 64 are then pivotally moved to their locking positions so that the hooks thereon engage the brackets 34 and 36 to lock the lid in place.

The numerals 66 refer to a series of truncated V-shaped connectors including legs 68 and 70 and a straight portion 72 extending between the lower ends of legs 68 and 70, as seen in FIG. 7. The upper ends of legs 68 and 70 have generally U-shaped eyes 72 and 74 formed therein respectively which are pivotally secured to ring 24. The connectors 66 are spaced apart a distance equal to one-half of the distance between the eyes 72 and 74. As seen, each leg of each connector 66 is crossed by a leg of the adjacent connector 66 to provide openings 75 therebetween which are of a size to permit a bird to enter the interior of the cage 20 but small enough to prevent a squirrel from entering the interior of the cage.

Lower cage portion 20B includes a support ring 76 having a series of truncated, inverted V-shaped connectors 78 secured thereto which extend upwardly therefrom. Each of the connectors 78 include legs 80 and 82 and a straight portion 84 extending between the upper ends of the legs 80 and 82. The lower ends of legs 80 and 82 have generally U-shaped eyes 86 and 88 formed therein respectively which are pivotally secured to ring 76.

The connectors 78 are spaced-apart a distance equal to one-half of the distance between the eyes 86 and 88. As seen, each leg of each connector 78 is crossed by a leg of the adjacent connector to provide openings 89 therebetween which are of a size to permit a bird to enter the interior of the cage but small enough to prevent a squirrel from entering the interior of the cage. A collar or sleeve 90 pivotally embraces the straight portions 72 of connectors 66 and the straight portions 84 of connectors 78.

Preferably, but not necessarily, a retaining ring 92 extends around the cage unit 20 at the juncture of the cage portions 20A and 20B with the retaining ring 92 being detachably secured to the cage unit 20 by clips or the like which are secured to at least some of the collars 90 to maintain the cage unit 20 in its extended position by preventing pivotal movement of the cage portions 20A and 20B with respect to each other.

Cage unit 22, including cage portions 22A and 22B is identical to cage unit 20 except that in most cases, the support ring 76 of cage unit 20 will serve as the upper support ring of the cage unit 22A. In some cases, it may be desirable to provide a separate upper support ring for the cage unit 22 with that support ring being secured to support ring 76 by any convenient means.

Preferably, but not necessarily, a retaining ring 94 extends around the cage unit 22 at the juncture of the cage portions 22A and 22B with the retaining ring 94 being detachably secured to the cage unit 20 by clips or the like which are secured to at least some of the collars thereon to maintain the cage unit 22 in its extended position by preventing pivotal movement of the cage portions 22A and 22B with respect to each other.

Cage unit 22 is provided with a plurality of wire members 96 at the lower end thereof which are secured to the lower support ring 98 of cage unit 22. The openings defined by the crossing wires 96 are sized to prevent squirrels from entering the interior of cage 20. If desired, a perforated plate could be provided at the lower end of the cage unit 22 rather than the wires 96.

Bird feeder assembly 14 is shown in the drawings as being comprised of a plurality of collapsible bird feeders 100 stacked one upon the other but a single bird feeder 100 could be utilized. Each of the bird feeders 100 is preferably comprised of collapsible metal mesh walls 102 such as described in U.S. Pat. Nos. 6,047,661; 6,073,582; 7,185,605; and 7,503,282. The uppermost bird feeder 100 has a central feed fill opening 104 formed therein which is positioned below opening 32 in plate 30 to enable feed to be placed into the bird feeders 100. When a plurality of bird feeders 100 are stacked one upon the other, as seen in FIG. 4, the lower end of the upper bird feeder 100 is open so as to communicate with the open upper end of the lower feeder 100 to permit feed to be supplied to the lower feeder. Preferably, the upper most bird feeder 102 has supports 106 extending therefrom for connection to the upper end of cage unit 12.

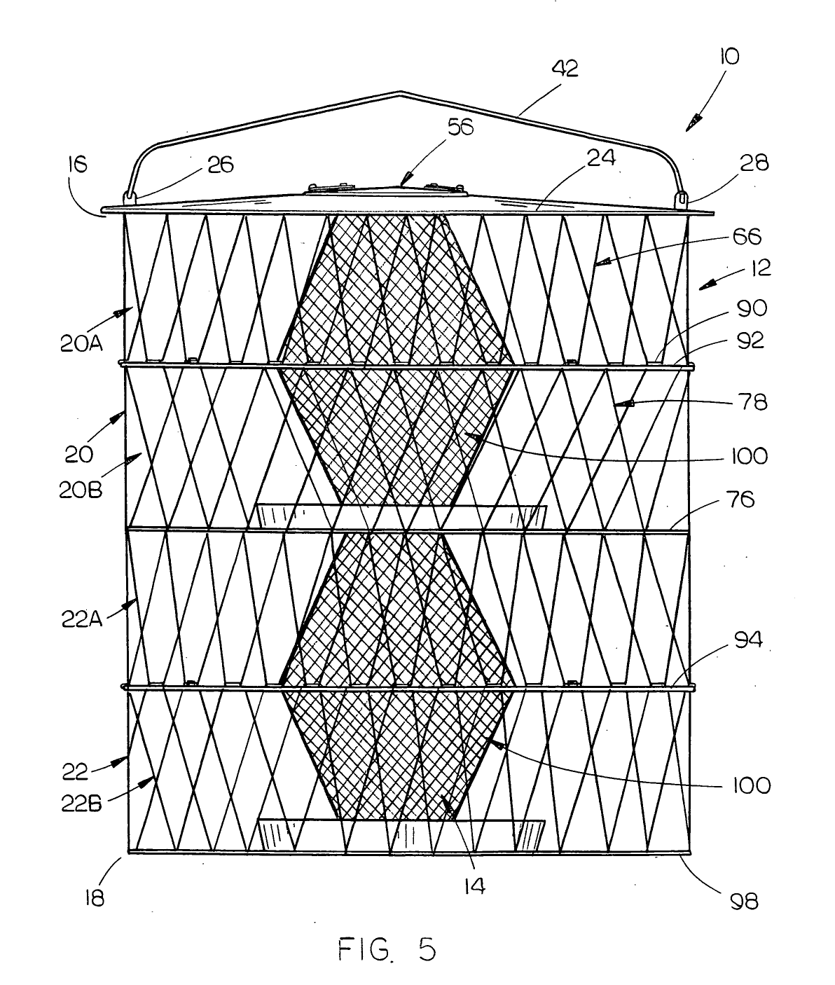

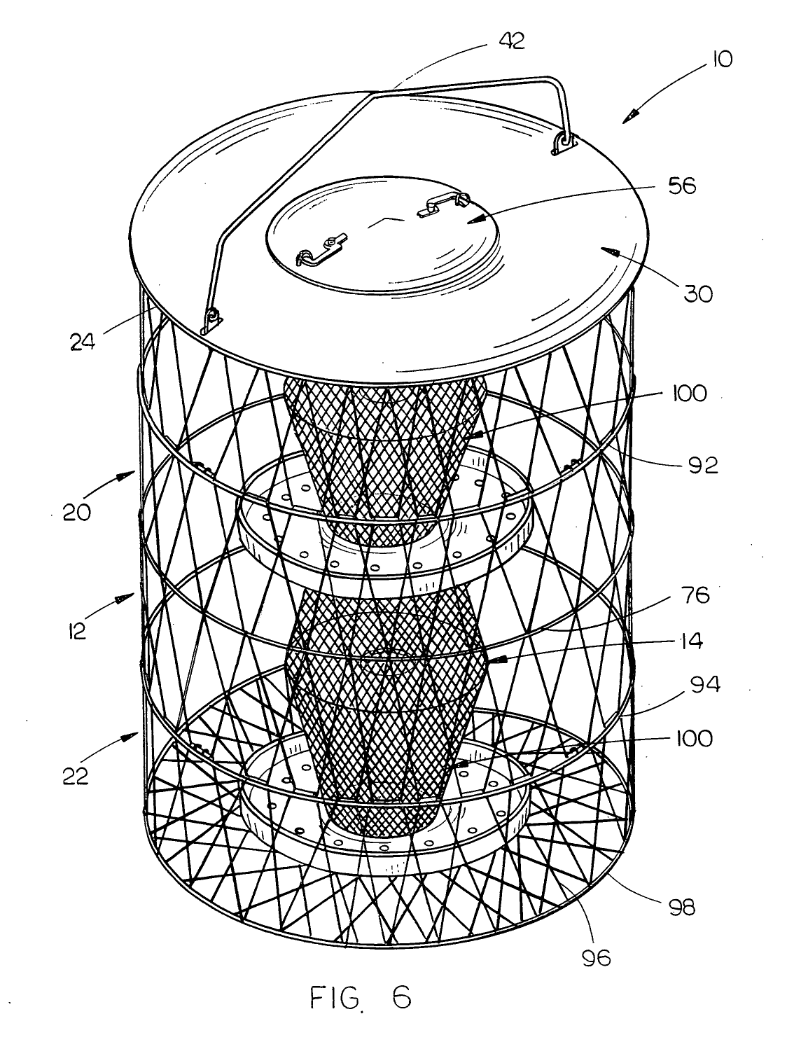

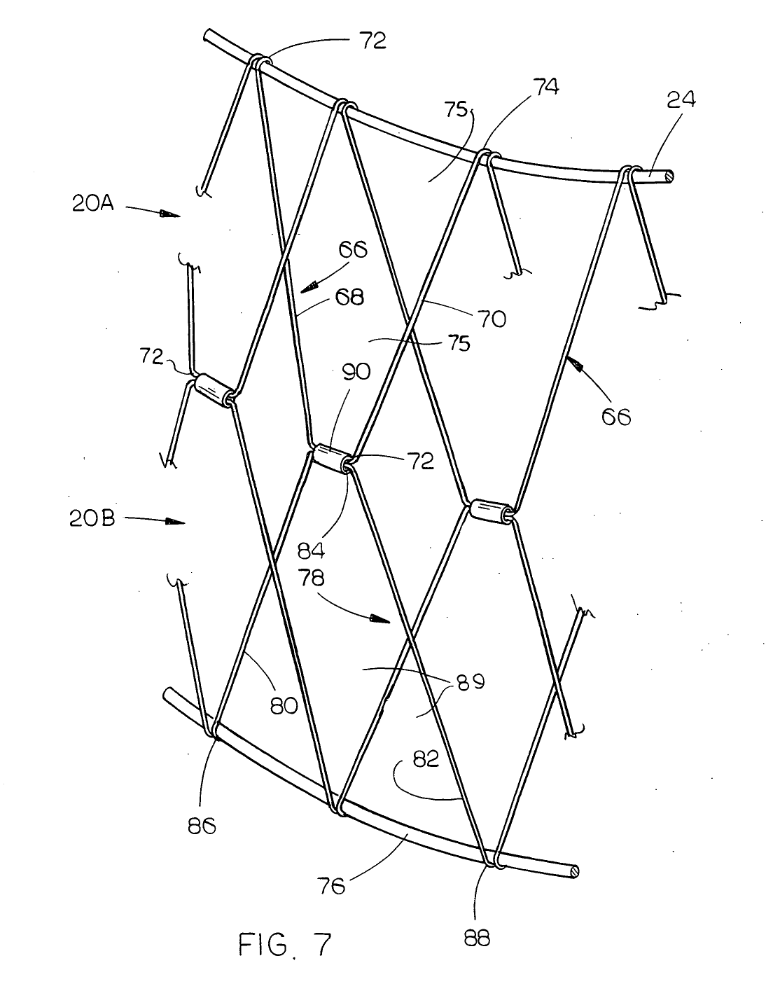

In use, such as seen in FIG. 5, the previously described openings in the cage 20 are spaced outwardly from the bird feeder 14 and are sized so as to permit birds to enter the interior of the cage 20 to feed from the bird feeders 100 but sized small enough to prevent squirrels from entering the interior of the cage.

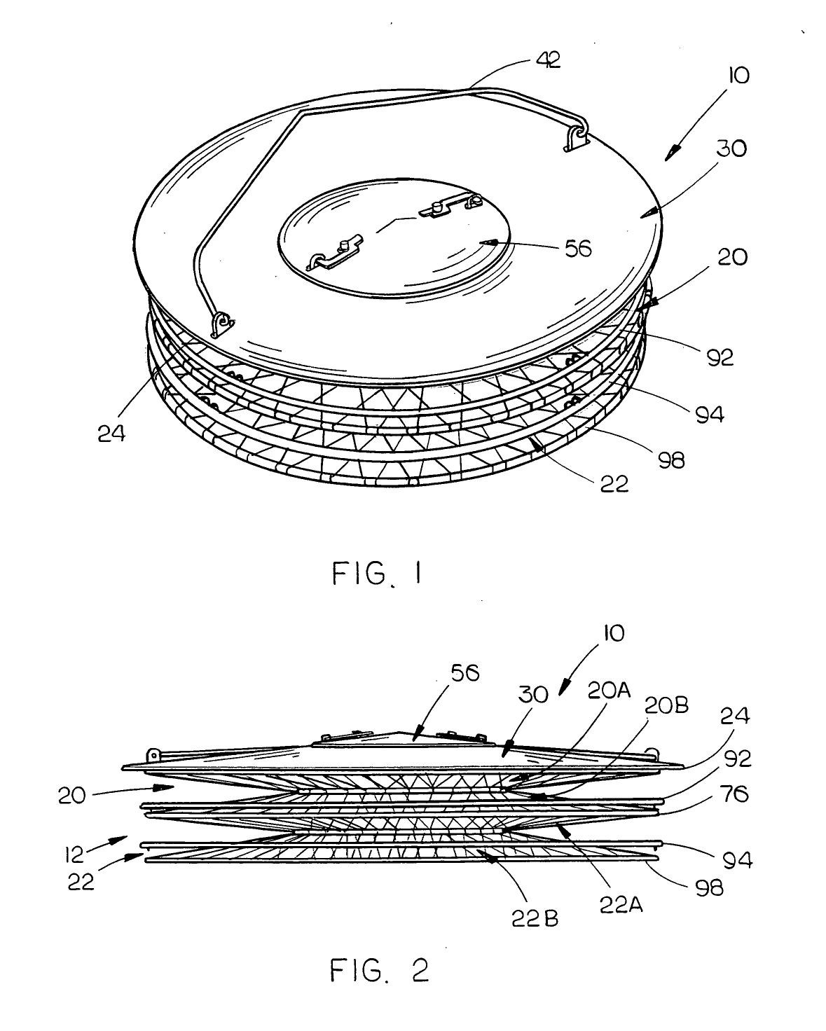

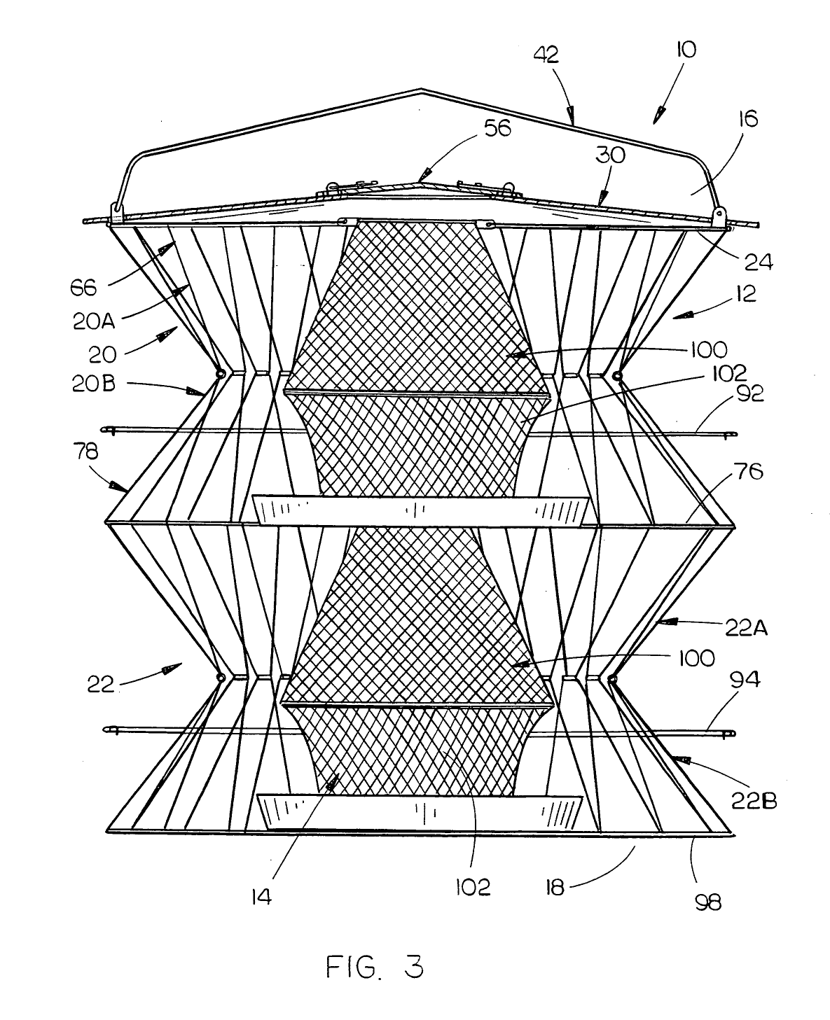

The fact that both the cage 20 and bird feeder assembly 14 are collapsible, the bird feeder 10 of this invention may be collapsed to the position of FIGS. 1 and 2 for shipping and storage purposes thereby occupying a small amount of space. When it is desired to use the bird feeder 10, the handle 42 is secured to some suitable support with the weight of the bird feeder assembly 14 causing the cage 20 and the bird feeders 100 to be positioned in their extended positions. At that time, the retaining rings 92 and 94 are clipped to the bird cage 20 as described above to maintain the cage 20 in its extended position. The weight of the bird feeder 14 hanging from the supports 106 will cause the bird feeder assembly 14 to remain in its extended position.

Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A collapsible squirrel-proof bird feeder, comprising:
a collapsible bird feeder capable of being movable between an extended feeding position and a collapsed position;
a metal collapsible outer squirrel guard cage surrounding said collapsible bird feeder and spaced therefrom which is selectively movable between an extended position and a collapsed position;
said collapsible outer squirrel guard cage having openings formed therein which are sized to permit birds to pass therethrough to feed from the collapsible bird feeder but small enough to prevent squirrels from passing therethrough to gain access to said collapsible bird feeder.

2. The collapsible squirrel-proof bird feeder of claim 1 wherein a plurality of vertically stacked collapsible bird feeders are positioned within said metal collapsible outer squirrel guard cage.

3. The collapsible squirrel-proof bird feeder of claim 1 wherein said collapsible bird feeder includes a collapsible metal mesh wall having feed opening defined therein when said bird feeder is in its said extended position.

4. The collapsible squirrel-proof bird feeder of claim 1 including structure which selectively maintains said squirrel guard cage in its said extended position.

5. A collapsible squirrel-proof bird feeder, comprising:
a first collapsible bird feeder including:
(a) a first ring-shaped support defining a central feed fill opening;
(b) a collapsible mesh wall having upper and lower ends;
(c) said first collapsible bird feeder being selectively movable between an extended position and a collapsed position;
(d) said upper end of said collapsible mesh wall being secured to said first ring-shaped support and extending downwardly therefrom;
(e) and a base secured to said lower end of said collapsible mesh wall;
(f) said collapsible mesh wall capable of being movable between an extended feeding position and a collapsed position;
a first collapsible outer squirrel guard including:
(a) a collapsible metal cage having an upper end and a lower end;
(b) said collapsible metal cage surrounding said first collapsible bird feeder so as to be spaced outwardly therefrom;
(c) said collapsible metal cage being selectively movable between an extended position and a collapsed position;
(d) said collapsible metal cage having openings formed therein which are sized to permit birds to pass therethrough, to feed from the first collapsible bird feeder but small enough to prevent squirrels from passing therethrough to gain access to said first collapsible bird feeder;
(e) said upper end of said collapsible metal cage having a selectively closable central feed fill opening positioned above said central feed fill opening of said first collapsible bird feeder;
(f) said lower end of said collapsible metal cage being positioned below said lower end of said first collapsible bird feeder;
the selective movement of said collapsible metal cage from its said extended position to its collapsed position causing said first collapsible bird feeder to also be moved from its said extended position to its said collapsed position.

6. The collapsible squirrel-proof bird feeder of claim 5 wherein said selectively closable feed fill opening in said collapsible metal cage is closable by a lid means.

7. The collapsible squirrel-proof bird feeder of claim 5 wherein said mesh wall of said first collapsible bird feeder is comprised of a metal material.

8. The collapsible squirrel-proof bird feeder of claim 5 wherein a feed tray is positioned at the lower end of said first collapsible bird feeder.

9. The collapsible squirrel-proof bird feeder of claim 5 wherein a second collapsible bird feeder is secured to said lower end of said first collapsible bird feeder.

10. The collapsible squirrel-proof bird feeder of claim 5 wherein said collapsible metal cage is comprised of a plurality of interconnected cage members.

11. The collapsible squirrel-proof bird feeder of claim 5 wherein said upper end of said first collapsible bird feeder is operatively secured to said upper end of said collapsible metal cage.

12. The collapsible squirrel-proof bird feeder of claim 5 further including means for selectively maintaining said collapsible metal cage in its said extended position.

13. The collapsible squirrel-proof bird feeder of claim 10 further including means for selectively maintaining said plurality of cage members in their said extended positions.

14. The collapsible squirrel-proof bird feeder of claim 13 wherein said means for selectively maintaining said collapsible metal cage in its said extended position comprises a ring member which embraces said collapsible metal cage and which is selectively secured thereto.
